(19) United States
(12) Patent Application Publication
(10) Pub. No.: US 2025/0307014 A1
(43) Pub. Date: Oct. 2, 2025

(54) PROCESSOR WITH DISPATCH BUFFER ALLOCATION AFFINITY CREDIT ADJUSTMENT

(71) Applicant: Tenstorrent USA, Inc., Austin, TX (US)

(72) Inventors: Divyansh Jagota, Raleigh, NC (US); Manan R. Salvi, San Jose, CA (US); Vignyan Kothinti, Redmond, WA (US)

(21) Appl. No.: 18/824,055

(22) Filed: Sep. 4, 2024

Related U.S. Application Data
(60) Provisional application No. 63/573,451, filed on Apr. 2, 2024.

(51) Int. Cl. G06F 9/50; G06F 9/38

(52) U.S. Cl. CPC G06F 9/5033; G06F 9/3856; G06F 9/5044

(57) ABSTRACT

Systems and methods related to one or more processors with dispatch buffer allocation affinity credit adjustment are disclosed herein. An instruction decoder and dispatch unit may have multiple dispatch buffers to which they may distribute instructions. Instruction pipelines may utilize a credits-based analysis to assign instructions to specific dispatch buffers based on various factors such as instruction affinity, resource requirements, execution characteristics, the affinities serviced by specific dispatch buffers, the cumulativeness of instruction affinities, availability in the dispatch buffers, the number of instructions that have been assigned to each dispatch buffer, and other factors. One instruction may affect the credits of another instruction. Leveraging affinities in dispatch buffer assignment and allocating instructions according to the credit system enhances the performance and scalability of instruction pipelines, assigns instructions to buffers efficiently, minimizes contention, reduces resource conflicts, and increases throughput.

### CROSS REFERENCE TO RELATED APPLICATIONS

This application claims the benefit of U.S. Provisional Patent Application No. 63/573,451, filed Apr. 2, 2024, which is incorporated by reference herein in its entirety for all purposes.

### BACKGROUND

The instruction pipeline is a fundamental component of a modern computer processor architecture. Instruction pipelines are designed to enhance performance by allowing multiple instructions to be processed simultaneously. In a typical pipeline, instructions flow through several stages, including fetch, decode, execute, memory access, and writeback. Each stage handles a specific aspect of instruction execution, enabling parallel processing and efficient resource utilization. As instructions progress through the pipeline, newer instructions can enter while older ones are still being executed, resulting in overlapping execution and improved throughput. However, pipeline hazards such as data dependencies and branch mispredictions can introduce stalls, slowing down the execution process. Despite these challenges, modern processors employ sophisticated techniques such as branch prediction and out-of-order execution to mitigate these issues and maximize performance.

Dispatch buffers are important elements of a modern instruction pipeline which serve as temporary storage units for instructions waiting to be executed. As part of the out-of-order execution process, instructions are fetched and decoded before being dispatched to their respective execution units. Dispatch buffers hold these instructions until all their dependencies are resolved and the required resources are available for execution. This allows for efficient utilization of the processor's resources by enabling instructions to execute in parallel, while also reducing stalls caused by dependencies or resource contention. Dispatch buffers are crucial components for achieving high performance in modern processors, as they help maintain a steady flow of instructions through the execution pipeline, thereby improving overall throughput and efficiency.

### SUMMARY

This disclosure relates to computer processor instruction pipelines. An instruction decoder and dispatch unit may have multiple dispatch buffers to which they may distribute instructions, each of which has differing affinities. Affinities may help optimize resource allocation and streamline the execution process by ensuring that instructions are dispatched to the most suitable buffers. For example, certain dispatch buffers may be specialized for arithmetic or logic operations, while others may prioritize branch or memory-related instructions. Some of the dispatch buffers (e.g., for memory-related instructions) may be configured to handle instructions of only a single affinity, while other dispatch buffers may be able to handle multiple instruction affinities.

In specific embodiments of the invention, instruction pipelines may utilize affinities to assign instructions to specific dispatch buffers based on various factors such as instruction affinity, resource requirements, and execution characteristics. In specific embodiments, approaches for assigning instructions to specific dispatch buffers are provided which account for the affinities serviced by specific dispatch buffers and target an even distribution of a workload of instructions across a set of dispatch buffers. The even distribution of the workload may account for the cumulativeness of instruction affinities, availability in the dispatch buffers, type (affinity) of the instructions, and other factors. A parallelized approach for dispatch buffer allocation may be utilized to achieve better timing and performance.

The approaches disclosed herein may include keeping track of how many instructions have been assigned to each dispatch buffer and performing a credits-based analysis to distribute instructions in a manner that improves efficiency and throughput. The credits may be adjusted based on the affinities of the dispatch buffers and may be used to determine how to distribute instructions to the dispatch buffers. Credits may be evaluated in the context of an instruction in a batch or bundle of instructions. In other words, one instruction may affect the credits of another instruction.

The approaches disclosed herein allow instructions to be assigned to buffers efficiently. For example, assigning instructions to buffers with affinities aligned with their execution requirements allows processors to minimize contention and reduce resource conflicts, thereby improving overall efficiency and throughput. Additionally, affinities enable processors to exploit parallelism effectively by allocating instructions to buffers in a way that maximizes resource utilization and minimizes pipeline stalls. Overall, leveraging affinities in dispatch buffer assignment and allocating instructions according to a credit system enhances the performance and scalability of instruction pipelines in modern computers.

In specific embodiments of the invention, a method for distributing instructions to dispatch buffers is provided. The method comprises: receiving a bundle of a plurality of instructions; determining, for a first dispatch buffer, a first number of credits, wherein the first dispatch buffer is able to process a first instruction affinity and a second instruction affinity; determining, for a second dispatch buffer, a second number of credits, wherein the second dispatch buffer is not able to process the first instruction affinity but is able to process the second instruction affinity; queuing a first instruction of the plurality of instructions for distribution to the first dispatch buffer based on the first instruction being of the first instruction affinity; adjusting the first number of credits based on the queuing of the first instruction; and queuing a second instruction of the plurality of instructions for distribution to either the first dispatch buffer or the second dispatch buffer based on a comparison of the adjusted first number of credits and the second number of credits.

In specific embodiments of the invention, a device is provided. The device comprises: a plurality of dispatch buffers including a first dispatch buffer and a second dispatch buffer; one or more processors; and instruction pipeline logic circuitry programmed to conduct a method for distributing instructions to the plurality of dispatch buffers. The method comprises: receiving a bundle of a plurality of instructions; determining, for the first dispatch buffer, a first number of credits, wherein the first dispatch buffer is able to process a first instruction affinity and a second instruction affinity; determining, for the second dispatch buffer, a second number of credits, wherein the second dispatch buffer is not able to process the first instruction affinity but is able to process the second instruction affinity; queuing a first instruction of the plurality of instructions for distribution to the first dispatch buffer based on the first instruction being of the first instruction affinity; adjusting the first number of credits based on the queuing of the first instruction; and queuing a second instruction of the plurality of instructions for distribution to either the first dispatch buffer or the second dispatch buffer based on a comparison of the adjusted first number of credits and the second number of credits.

In specific embodiments of the invention, a method for distributing instructions to dispatch buffers is provided. The method comprises: receiving a bundle of a plurality of instructions, each instruction of the plurality of instructions having an instruction type; determining, for a dispatch buffer, a number of credits, wherein the number of credits is based at least in part on an amount of space available within the dispatch buffer, an affinity of the dispatch buffer for one or more instruction types, and a quantity of instructions of the plurality of instructions that are associated with the one or more instruction types; and queuing an instruction of the plurality of instructions for distribution to the dispatch buffer based at least in part on the number of credits, the affinity of the dispatch buffer, and the instruction type of the instruction.

### BRIEF DESCRIPTION OF THE DRAWINGS

The accompanying drawings illustrate various embodiments of systems, methods, and various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides an example of instruction dispatch circuitry in accordance with specific embodiments of the inventions disclosed herein.

FIG. 2 provides an example of distributing instruction to dispatch buffers based on instruction affinities and dispatch buffer credits in accordance with specific embodiments of the inventions disclosed herein.

FIG. 3 provides an example of the process of an instruction being distributed to a dispatch buffer in accordance with specific embodiments of the inventions disclosed herein.

FIG. 4 provides an example of steps for distributing instructions to dispatch buffers based on credits and accumulated instructions in accordance with specific embodiments of the inventions disclosed herein.

FIG. 5 provides an example of a flowchart for deciding to which dispatch buffer to allocate an instruction to in accordance with specific embodiments of the inventions disclosed herein.

FIG. 6 provides an example of a method for distributing instructions to a first and a second dispatch buffer in accordance with specific embodiments of the inventions disclosed herein.

FIG. 7 provides an example of a method for distributing instructions to a first, a second, and a third dispatch buffer in accordance with specific embodiments of the inventions disclosed herein.

FIG. 8 provides an example of a method for distributing instructions to a first, a second, a third, and a fourth dispatch buffer in accordance with specific embodiments of the inventions disclosed herein.

FIG. 9 provides an example of a method for distributing instructions to a dispatch buffer based on a number of credits in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for one or more processors with dispatch buffer allocation affinity credit adjustment in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

Systems and methods related to computer processor instruction pipelines are disclosed herein. An instruction decoder and dispatch unit have multiple dispatch buffers to which they can distribute instructions, each of which has differing affinities. Affinities help optimize resource allocation and streamline the execution process by ensuring that instructions are dispatched to the most suitable buffers. For example, certain dispatch buffers may be specialized for arithmetic or logic operations, while others may prioritize branch or memory-related instructions. Some of the dispatch buffers (e.g., for memory-related instructions) may be configured to handle instructions of only a single affinity, while other dispatch buffers may be able to handle multiple instruction affinities. In instances where an instruction may potentially be distributed to multiple dispatch buffers based on its affinity, some approaches have attempted to evenly allocate instruction distribution to dispatch buffers such as through round-robin approaches.

In specific embodiments of the invention, instruction pipelines utilize affinities to assign instructions to specific dispatch buffers based on various factors such as instruction affinity, resource requirements, and execution characteristics. In specific embodiments, approaches for assigning instructions to specific dispatch buffers are provided which account for the affinities serviced by specific dispatch buffers and target an even distribution of a workload of instructions across a set of dispatch buffers. For example, cumulativeness of instruction affinities is accounted for and a parallelized approach for dispatch buffer allocation is utilized to achieve better timing and performance. By assigning instructions to buffers with affinities aligned with their execution requirements, processors can minimize contention and reduce resource conflicts, thereby improving overall efficiency and throughput. Additionally, affinities enable processors to exploit parallelism effectively by allocating instructions to buffers in a way that maximizes resource utilization and minimizes pipeline stalls. Overall, leveraging affinities in dispatch buffer assignment enhances the performance and scalability of instruction pipelines in modern computers.

The approaches disclosed herein include logic circuits that are designed to keep track of how many instructions have been assigned to each dispatch buffer and perform a credits-based analysis to distribute instructions in a manner that improves efficiency and throughput. The logic circuits can be part of an instruction decoder or instruction dispatch unit that is responsible for distributing instructions to the dispatch buffers. The number of instructions assigned to each buffer can be used to determine an effective credit for that dispatch buffer as compared to the other dispatch buffers in the instruction pipeline. The logic circuits are further designed to account for the affinities of the dispatch buffers in a specific manner to adjust those credits. The credits can then be used to determine how to distribute instructions to the dispatch buffers. The instructions can be distributed to specific dispatch buffers by binning them into dispatch buffer slots. In specific embodiments, the logic circuits evaluate the instructions in batches of instructions that are operated on in a bundle. The instruction decoder or instruction dispatch unit can operate as part of the instruction pipeline by continuously receiving the instructions in an instruction bundle, conducting the methods disclosed herein, and dispatching the instructions to the dispatch buffers accordingly.

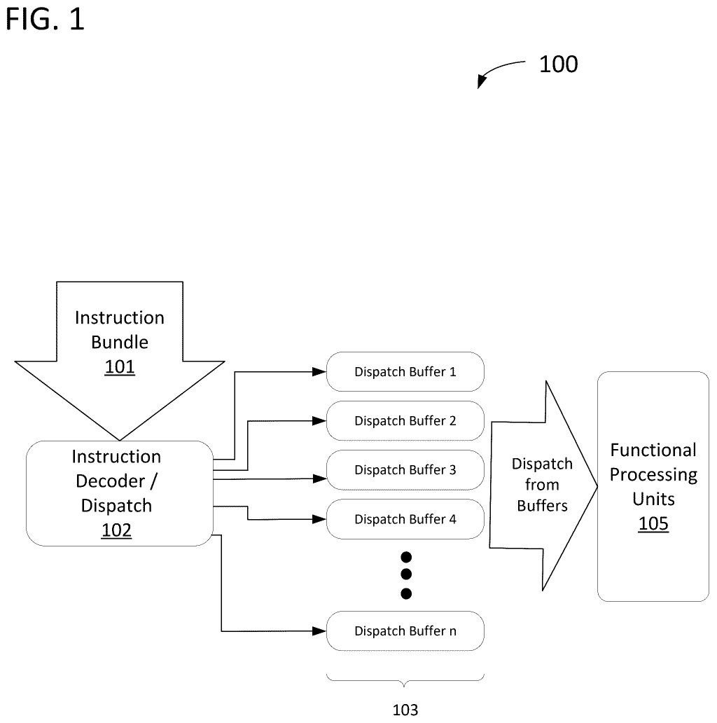

FIG. 1 depicts exemplary instruction dispatch circuitry 100. FIG. 1 is simplified for purposes of illustrating embodiments of the present disclosure, and it will be understood that components therein can be embodied with a variety of circuitry and/or processing circuitry, combinatorial logic circuits implemented with asynchronous or synchronous Boolean logic gates, hardware-instantiated state machines, controllers, processors, microprocessors, FPGAS, ASICs, and the like, as well as any associated registers or other memory for storing and providing access to data or instructions, which alone and in combination are generally described as “logic circuits” herein. In the example depicted in FIG. 1, the instruction dispatch circuitry 100 includes instruction decoder/dispatch 102, plurality of dispatch buffers 103 (the dispatch buffers being 1-n), and functional processing units 105.

Instruction decoder/dispatch 102 is depicted as a single set of logic circuits but can be implemented with multiple logic circuits (e.g., of different portions of circuitry and/or instruction sets executed by processors or controllers) depending on the implementation. Instruction decoder/dispatch 102 receives instructions (e.g., instruction bundle 101) for distribution to dispatch buffers 103. In some embodiments, the instructions may be received in bundles of instructions (such as instruction bundle 101), although in different implementations the bundling may be performed by instruction decoder/dispatch 102 and/or rebundling may be performed by instruction decoder/dispatch 102. Instruction decoder/dispatch 102 has information indicating a present state of each of the dispatch buffers 103, such as which instructions have previously been distributed to each dispatch buffer 103, how much space is available in each dispatch buffer 103, and instruction affinities available to each dispatch buffer 103. The information can be in the form of stored data in instruction decoder/dispatch 102 as updated by actions taken by instruction decoder/dispatch 102 and optionally as updated by information fed back from down-stream elements such as the dispatch buffers 103. The information can also be in the form of hard coded or stored data regarding the characteristics of down-stream elements such as dispatch buffers 103. For example, some dispatch buffers 103 may only be configured to process and dispatch instructions of a particular instruction affinity such as memory-related instructions, and some buffers may be configured to process and dispatch instructions of multiple affinities. Based on these configurations of dispatch buffers 103, some instruction affinities may be distributed to multiple dispatch buffers. Where an instruction is of an instruction affinity that may be able to be distributed to multiple dispatch buffers, some approaches have attempted to evenly allocate instruction distribution to dispatch buffers 103 such as through round-robin approaches. The present approach utilizes tracking of instruction distribution and dispatch buffer utilization via an accumulation vector and credit tracking logic and follows criteria for distribution that optimize throughput and efficiency.

In embodiments of the present disclosure, instruction decoder/dispatch 102 (e.g., via its logic circuits) performs a token handshake with some or all dispatch buffers 103 (e.g., all dispatch buffers that may process instructions of multiple instruction affinities and that process instruction affinities that may be distributed to multiple dispatch buffers for processing) to get information about the dispatch buffers, such as how many empty spaces are available in each dispatch buffer. This handshake may be performed at a variety of times, such as periodically or when a bundle of instructions (such as instruction bundle 101) is being prepared to be sent to a dispatch buffer (of dispatch buffers 103). This information is utilized to determine an initial number of “credits” for each of the dispatch buffers (e.g., a subset of dispatch buffers of dispatch buffers 103 that had a token handshake). The credits in turn may be based on the space available within each dispatch buffer, as well as other information such as processing and distribution timing from the dispatch buffer, workload of the dispatch buffer for processing different instruction affinities, number of instructions of certain instruction affinity types, and other factors or information about each respective dispatch buffer. As each respective bundle of instruction is distributed to a dispatch buffer, the credits for each dispatch buffer are adjusted, such that each subsequent instruction bundle that is distributed to a dispatch buffer has up to date information for optimized distribution.

Each instruction is distributed to a respective dispatch buffer based on its instruction affinity, the respective number of credits associated with each dispatch buffer, and various thresholds and values determined from the number of credits. For example, for a set of available dispatch buffers for a particular instruction, a respective difference in credits for each dispatch buffer may be assessed versus dynamic thresholds to determine the most effective allocation of the instruction for the overall utilization and efficiency of the dispatch buffers. For example, whether a dispatch buffer has limited space, or processes instruction affinities for which there is limited space, can be determined based on the credits and calculations and comparisons of the credits.

Dispatch buffer assignment can be conducted in parallel for all the instructions in a bundle. The logic circuits can take the cumulative credits from the various dispatch buffers available via the handshake with the dispatch buffers, described above, take the instruction types in the instruction bundle, and can then, in a single clock cycle, compute an accumulation vector or cumulative distribution vector for each affinity type for the instruction bundle as well as an effective credit vector for the various instructions. Accordingly, the accumulation vector and effective credits vector can be utilized for the effective position-based credit utilization for each instruction, binning each instruction into its most effective dispatch buffer slot in parallel.

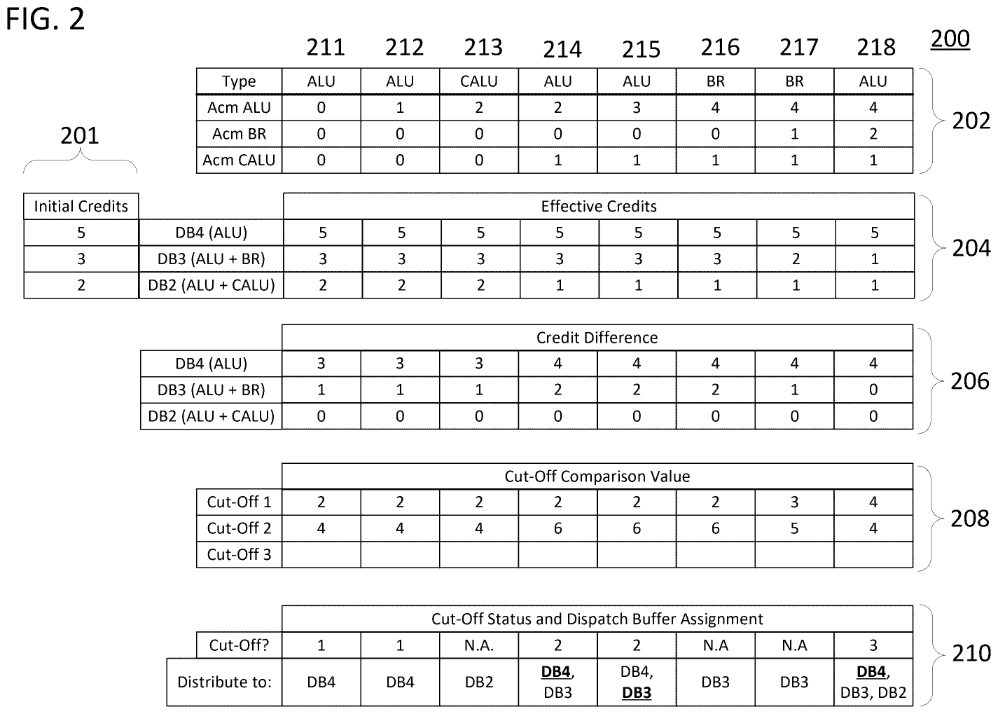

An example of distributing instructions to dispatch buffers based on instruction affinities and dispatch buffer credits is depicted in FIG. 2. Although FIG. 2 is described in the context of particular instruction affinities, a particular number of affinities, a particular set of dispatch buffers accommodating different affinities, difference and threshold calculations, and the like, it will be understood that FIG. 2 is exemplary only and that the use of instruction affinities and dispatch buffer credits can be modified in a variety of manners, for example, based on additional instruction affinities having multiple dispatch buffers that can accommodate the instruction affinity (e.g., in addition to instruction type ALU having three dispatch buffers that can process its instruction affinity, another instruction type having two or more dispatch buffers for its affinity), different criteria for optimum distribution and dispatch buffer utilization (e.g., certain dispatch buffers requiring more available space for high-priority instructions), difference threshold criteria (e.g., less than or equal to, greater than or equal to, different distribution for equal to vs. greater than or less than, etc.), and the like.

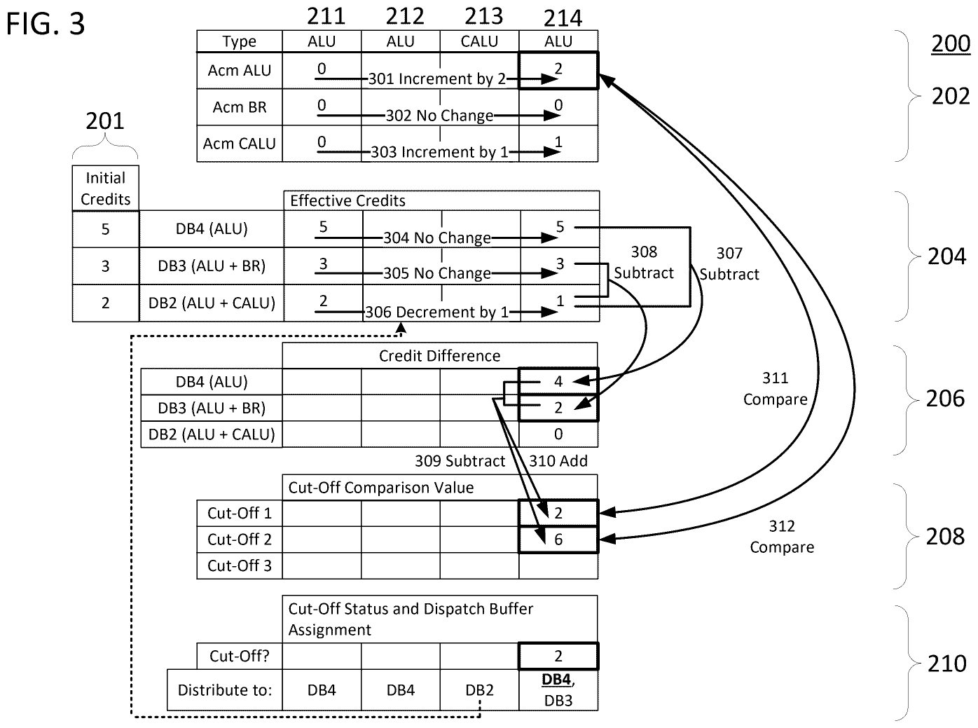

In the embodiment depicted in FIG. 2, processing 200 (e.g., by logic circuits of instruction decoder/dispatch) of a bundle of instructions in an embodiment of the present disclosure is depicted. Operations are depicted in tabular form, with sub-tables for different operational steps performed during the distribution to the dispatch buffers, including a sub-table for initial credits (e.g., “initial credits 201”), a sub-table for an accumulation vector of distributed instructions (e.g., “accumulation vector 202”), a sub-table for calculated effective credits (e.g., “effective credits 204”), a sub-table for credit difference values (e.g., “credit difference 206”), a sub-table for cut-off comparison values (e.g., “cut-off thresholds 208”), and a sub-table for cut-off status and dispatch buffer assignment (e.g., “dispatch buffer assignment 210”). The columns of each of the sub-tables are aligned and correspond to respective distributed instructions 211-218 of an instruction bundle, e.g., that are processed as a bundle by the logic circuits of the instruction decoder/dispatch. Instructions may also be referred to as messages. FIG. 3 provides a more focused look on instruction 214, demonstrating a portion of processing 200 more specifically.

Each of the sub-tables will be briefly described initially and then described in more detail further below for a specific example of a bundle of instructions to be distributed to the dispatch buffers. An exemplary accumulation vector 202 accumulates the number of instructions of each affinity that have been distributed to a dispatch buffer for the bundle of instructions, and thus, in the example depicted in FIG. 2, begins with all instruction affinities having a value of zero. An exemplary set of effective credits 204 is a dynamically adjusted count of credits associated with each dispatch buffer as instructions are distributed to the dispatch buffers, and initially has values equal to the initial credits 201. An exemplary credit difference 206 includes difference values that are determined based on the effective credits 204, for example, with a first difference value for the dispatch buffer having the highest effective credits being a difference between that dispatch buffer's effective credits and the number of effective credits for the dispatch buffer having the lowest number of effective credits, with the second difference value being for the second highest number of effective credits minus the lowest number of effective credits, and so on until the dispatch buffer having the lowest number of effective credits has a value of zero. An exemplary set of cut-off thresholds 208 includes values that are calculated from the credit difference values to provide for effective allocation of instructions to dispatch buffers based on the respective availabilities and affinities within the dispatch buffers. An exemplary cut-off 1 is a cut off to send an instruction of a certain affinity to the dispatch buffer having the highest effective credits and is calculated from the credit difference for that dispatch buffer minus the credit difference for the dispatch buffer having the next highest effective credits. An exemplary cut-off 2 is a cut off to send an instruction of a certain affinity to either the dispatch buffer having the highest effective credits, or the dispatch buffer having the next highest effective credits (e.g., with the choice between the two dispatch buffers being determined round-robin) and is calculated by adding the credit difference values for these two dispatch buffers together. An exemplary cut-off 3 has no value associated with it in the depicted embodiment of FIG. 2 and represents any value greater than the cut-off 2 value but may have a value in different implementations with more than three relevant dispatch buffers (e.g., based on additional difference or additive calculations). If cut-off 3 is invoked (e.g., the accumulation value is equal to or higher than cut-off 2), an instruction of a certain affinity may be sent to either the dispatch buffer having the highest effective credits, the dispatch buffer having the second highest effective credits, or the dispatch buffer having the third highest effective credits (e.g., with the choice between the three dispatch buffers being determined round-robin), which in the example of FIG. 2, is any dispatch buffer. An exemplary dispatch buffer assignment 210 depicts a cut-off value which is based on a comparison, for the associated column 211-218, of the accumulation value from accumulation vector 202 of the instruction being distributed to the cut-offs of cut-off thresholds 208, and based on that comparison, to which dispatch buffer or buffers the instruction may be distributed.

In the example of FIG. 2, a bundle is acquired that includes eight instructions of three instruction affinities, ALU (arithmetic logic unit), CALU (complex arithmetic logic unit), and BR (branch), with a total of five ALU affinity instruction (e.g., based on five ALU instructions in the “Type” row of accumulation vector 202), two BR instructions (e.g., based on two BR instructions in the “Type” row of accumulation vector 202), and one CALU instruction (e.g., based on two BR instructions in the “Type” row of accumulation vector 202).

In the example of FIG. 2, three dispatch buffers DB2, DB3, and DB4 are available for the bundle of instructions. Another exemplary dispatch buffer such as DB1 may not be available for any of the instructions of the bundle, for example, based on exclusive distribution of memory-related instructions to DB1. As another example of why DB1 is not depicted, the particular bundle may not include any instructions having an affinity that is available for processing by DB1. It will be noted that the dispatch buffers being considered may be adjusted for each bundle, e.g., based on the particular affinities within the bundle. Returning to FIG. 2, dispatch buffer DB4 is only configured for the ALU affinity, while dispatch buffer DB3 is configured for both the ALU and BR affinities, and dispatch buffer DB2 is configured for both the ALU and CALU affinities. Thus, in the particular example depicted in FIG. 2, instructions of the ALU affinity can be distributed to any of DB2, DB3, or DB4, while instructions of the BR affinity may only be distributed to DB3 and instructions of the CALU affinity may only be distributed to DB2.

A token handshake is initially performed to acquire the initial credits 201 for each dispatch buffer, which in the example of FIG. 2, is five credits for DB4, three credits for DB3, and two credits for DB2. As can be seen from these initial credits, DB2 has the lowest availability for ALU instructions that may be distributed to any of the dispatch buffers. As will be seen from FIG. 2, the dynamic credit and accumulation techniques described herein avoid unnecessarily distributing an instruction with an ALU affinity to DB2 until appropriate.

Before distribution of the first instruction 211 having an ALU affinity, there are no accumulated instructions within accumulation vector 202, and thus, all values are zero. The effective credits 204 values are set to the values of the initial credits 201. Thus, the credit differences 206 for instruction 211 are three for DB4 (e.g., based on five effective credits for DB4 minus two effective credits for DB2), one for DB3 (e.g., based on three effective credits for DB3 minus two effective credits for DB2), and zero for DB2 (e.g., based on DB2 having the lowest number of effective credits). The cut-off values are then determined, with Cut-Off 1 having a value of two (e.g., based on the credit difference value of three for DB4 minus the credit difference value of one for DB3) and Cut-Off 2 having a value of four (e.g., based on the credit difference value of three for DB4 plus the credit difference value of one for DB3). The value of zero within the accumulation vector 202 for instruction 211 is then compared to the cut-off values, and because it is less than the cut-off value, falls within Cut-Off 1. Because Cut-Off 1 is associated exclusively with DB4, instruction 211 is distributed to dispatch buffer 4 for further processing.

Although the tables in FIG. 2 are conducted in parallel, the values of the various sub-tables are adjusted according to particular criteria which include the affinities of the other instructions in the bundle. Within accumulation vector 202, the values within the vector are incremented based on the affinity of the other instructions, such that for instruction 212, there is a value of “1” within the accumulation vector for the ALU affinity based on the affinity of instruction 211. Effective credits are distributed according to predetermined rules set based on the distribution options for the different instruction affinities. For example, because DB4 only handles a single instruction affinity of a type (e.g., ALU), which type may be distributed to any dispatch buffer in the example (DB2, DB3, and DB4 all have ALU affinities), where the other dispatch buffers (DB2 and DB3) have additional affinities beyond ALU (CALU for DB2 and BR for DB3), DB4 is given priority for ALU instructions and the effective credits for DB4 are accordingly not decremented when DB4 queues an ALU instruction. However, if an instruction is intended for distribution to a dispatch buffer that is the only buffer that can handle a certain affinity type (e.g., the buffer has a specialized affinity), the effective credits for that buffer may be decremented. This is depicted, for example, for instruction 213 and 214 (intended distribution of CALU instruction 213 to DB2, and the corresponding adjustment of effective credits for DB2 in preparation for assigning instruction 214). The sub-tables are adjusted and processed based on the queuing of instruction 212 as previously described for instruction 211.

Referring now to instruction 213, the instruction is of a CALU affinity type, and thus, may only be distributed to buffer DB2. Accordingly, while all the values of the sub-tables 202-208 are adjusted for instruction 213, the “Cut-Off” value for dispatch buffer assignment (e.g., buffer distribution) is set to N/A since the instruction can only be distributed to dispatch buffer 2. Accordingly, the accumulation vector for instruction 214 has a value of “1” for the CALU instruction affinity while the value of “2” is retained for the ALU instruction affinity. The effective credits for DB2 are decremented from “2” to “1” based on the intended distribution of the CALU instruction to DB2. Accordingly, the credit differences 206 are adjusted to four for DB4 (e.g., five effective credits for DB4 minus one effective credit for DB2) and two for DB3 (e.g., three effective credits for DB3 minus one effective credit for DB2). The cut-off thresholds are also adjusted, with Cut-off 1 retaining a value of “2” (e.g., based on the credit difference for DB3 subtracted from the credit difference for DB4) while the Cut-off 2 increases from “4” to “6” (e.g., based on the credit difference for DB3 added to the credit difference for DB4). This increase in Cut-off 2 effectively renders it much less likely that an instruction will be distributed to DB2 unless it is of the CALU affinity, since the accumulation value would have to be greater than or equal to 6. In this manner, messages are routed to the appropriate dispatch buffers based on the buffers' ability to accommodate additional messages efficiently. Based on the accumulation value “2” of instruction 214 being equal to or greater than the Cut-Off 1 value of “2” (e.g., equal to), instruction 214 may be distributed to either DB4 or DB3. In the example embodiment of FIG. 2, instruction 214 is distributed to DB4, although in some embodiments the choice between multiple options for distribution may be based on rules or other criteria, for example, in a round-robin fashion or by defaulting to the dispatch buffer having the highest effective credits.

Instruction 215 may be processed similarly to instruction 214 and may also have the option of being distributed to DB3 or DB4. In the example embodiment of FIG. 2, instruction 215 is distributed to DB3, although in some embodiments the choice between multiple options for distribution may be based on rules or other criteria, for example, in a round-robin fashion or by defaulting to the dispatch buffer having the highest effective credits.

Referring now to instructions 216 and 217, two consecutive BR affinity instructions are received and intended for distribution to dispatch buffer 3 (DB3). As a result, for instruction 218 having ALU affinity, the accumulation vector 202 has values of four for the ALU affinity, two for the BR affinity, and one for the CALU affinity. The effective credits 204 for DB4 remain at five as described herein, whereas the effective credits for each of DB3 and DB2 have been reduced to one. Accordingly, the difference values are four for DB4 (e.g., four for DB4 minus zero for both of the other buffers) and zero for both DB3 and DB2 (e.g., since both DB3 and DB2 have the same credit difference of zero). The cut-off thresholds 208 are both four, since four minus zero is four for Cut-Off 1 and four plus zero is four for Cut-Off 2. Based on the accumulation value for instruction 218 of four being greater than or equal to the Cut-Off 1 and Cut-Off 2 thresholds of four (e.g., equal to), instruction 218 is within Cut-Off 3 and can be distributed to any of the dispatch buffers DB2, DB3, or DB4. As there are no Cut-Off 3 values in FIG. 2, any accumulation value that exceeds Cut-Off 1 and Cut-Off 2 is assigned to Cut-Off 3. By performing a credits-based analysis to distribute instructions, efficiency and throughput of the system may be improved.

FIG. 3 depicts a process of determining which dispatch buffer to assign instruction 214. In other words, FIG. 3 provides a focused look on instruction 214 of FIG. 2 in accordance with the present disclosure, following the same processing 200. Some values from FIG. 2 have been omitted for clarity, but it is understood that the values of FIG. 2 are still applicable in FIG. 3. In the example of FIG. 3, three dispatch buffers DB2, DB3, and DB4 are available for the bundle of instructions. It will be noted that the dispatch buffers being considered may be adjusted for each bundle, e.g., based on the particular affinities within the bundle. Dispatch buffer DB4 is only configured for the ALU affinity, while dispatch buffer DB3 is configured for both the ALU and BR affinities, and dispatch buffer DB2 is configured for both the ALU and CALU affinities. Thus, in the particular example depicted in FIG. 3, instructions of the ALU affinity can be distributed to any of DB2, DB3, or DB4, while instructions of the BR affinity may only be distributed to DB3 and instructions of the CALU affinity may only be distributed to DB2.

The initial credits 201 for each dispatch buffer, in the example of FIG. 3, are five credits for DB4, three credits for DB3, and two credits for DB2. As can be seen from these initial credits, DB2 has the lowest availability for ALU instructions that may be distributed to any of the dispatch buffers. DB2, however, has the highest availability for CALU instructions, as it is the only dispatch buffer with an affinity for them. As will be seen from FIG. 3, the dynamic credit and accumulation techniques described herein avoid unnecessarily distributing an instruction with an ALU affinity to DB2. In some examples, this may ensure that DB2 is able to take CALU instructions, DB2 being the only dispatch buffer with CALU affinity in the example of FIG. 3. Similarly, more ALU instructions may be sent to DB4 than to DB3, as DB3 is the only dispatch buffer with an affinity for BR instructions.

Although the tables in FIG. 3 are conducted in parallel, the values of the various sub-tables are adjusted according to particular criteria which include the affinities of the other instructions in the bundle. Within accumulation vector 202, the values within the vector are incremented based on the affinity of the other instructions. Accordingly, instruction 211 (ALU affinity), instruction 212 (ALU affinity), and instruction 213 (CALU affinity) are taken into account when distributing (or queuing to distribute) instruction 214 to a dispatch buffer. In this example, for processing instruction 214, accumulation vector 202 accounts for two accumulated ALU instructions at step 301, zero accumulated BR instructions at step 302, and one accumulated CALU instruction at step 303.

Effective credits are distributed according to predetermined rules set based on the distribution options for the different instruction affinities. For example, because DB4 only handles a single instruction affinity of a type (e.g., ALU) that may be distributed to multiple dispatch buffers, the effective credits for DB4 are not decremented based on ALU affinity instructions which are intended for distribution to DB4. DB4 is given priority for ALU instructions, as DB4 only has an affinity for ALU instructions while both DB2 and DB3 have specialized affinities (affinities for CALU and BR, respectively, in addition to affinities for ALU). Since DB2, DB3, and DB4 all share an affinity for ALU instructions, the system may refrain from decrementing effective credits when an instruction (which will be an ALU instruction) is queued for distributing to DB4. Thus, for processing instruction 214, even though instruction 211 and instruction 212 have been distributed (or queued for distributing) to DB4, the effective credits of DB4 remain at five at step 304.

As no instructions are intended for DB3 yet (instruction 211 and instruction 212 are intended for DB4 and instruction 213 is intended for DB2), at step 305 there is no change in the amount of effective credits for DB3.

If an instruction is intended for distribution to a dispatch buffer that is the only buffer that can handle a certain affinity type, or that handles multiple affinity types, the effective credits for that buffer are decreased. For example, instruction 213 (CALU affinity) is intended for distribution to DB2. At step 306, the effective credits of DB2 are decreased from the initial value (two effective credits for DB2) by one (to one effective credits for DB2) due to processing instruction 213.

The credit differences 206 are adjusted based on the difference between the given effective credit of a dispatch buffer and the lowest effective credit of a dispatch buffer (e.g., DB2). In this example, for processing instruction 214, the credit difference of DB4 is four (e.g., five effective credits for DB4 minus one effective credit for DB2 at step 307) and the credit difference of DB3 is two (e.g., three effective credits for DB3 minus one effective credit for DB2 at step 308). The credit difference for DB2 is zero, as DB2 has the lowest number of effective credits (e.g., one effective credit for DB2 minus one effective credit for DB2).

Cut-off 1 for instruction 214 has a value of two, based on the credit difference for DB4 (four) minus the credit difference for DB2 (two) at step 309. Cut-off 2 is six, based on the credit difference for DB4 (four) added to the credit difference for DB3 (two) at step 310. This relatively high value for Cut-off 2 effectively renders it much less likely that an ALU instruction will be distributed to DB2, since the accumulation value of the ALU instruction would have to be greater than or equal to six. A future CALU instruction may still be intended for DB2, as DB2 is the only dispatch buffer with an affinity for CALU type instructions.

At step 311, the accumulation value corresponding to the type of instruction is compared to Cut-Off 1. Instruction 214 is ALU type, so the accumulation value of ALU is compared to Cut-Off 1. In this case, the accumulation value (2) of instruction 214 is not less than the Cut-Off 1 value (2). Accordingly, instruction 214 is associated with Cut-Off 2 and may be distributed to either DB4 or DB3 (the dispatch buffer with the highest amount of effective credits or the dispatch buffer with the second highest amount of effective credits). The choice between DB4 or DB3 may be determined round-robin or preference may be given to the buffer with the highest amount of effective credits.

In specific embodiments, at step 312, the accumulation value may also be compared to Cut-Off 2. The accumulation value may be compared to Cut-Off 2 if, for example, the accumulation value was greater than Cut-Off 1, or if Cut-Off 1 and Cut-Off 2 had the same value (e.g., 2). In specific embodiments where the accumulation value of instruction 214 is equal to or more than Cut-Off 2, instruction 214 is placed in the category of Cut-Off 3. Instruction 214 may be distributed to either DB4, DB3, or DB2 in accordance with the rules of Cut-Off 3 and the choice of DB4, DB3, or DB2 may be round-robin. In the case where cut-offs have the same value, preference is given to the higher cut-off, as this may maximize instruction distribution.

In the example embodiment of FIG. 3, instruction 214 is distributed to DB4, although in some embodiments the choice between multiple options (e.g., DB3 or DB4) for distribution may be based on rules or other criteria, for example, in a round-robin fashion or by defaulting to the dispatch buffer having the highest effective credits.

By assigning and comparing credits, instructions (e.g., messages) are routed to the appropriate dispatch buffers based on the buffers' ability to accommodate additional messages efficiently. The system may have improved throughput as well.

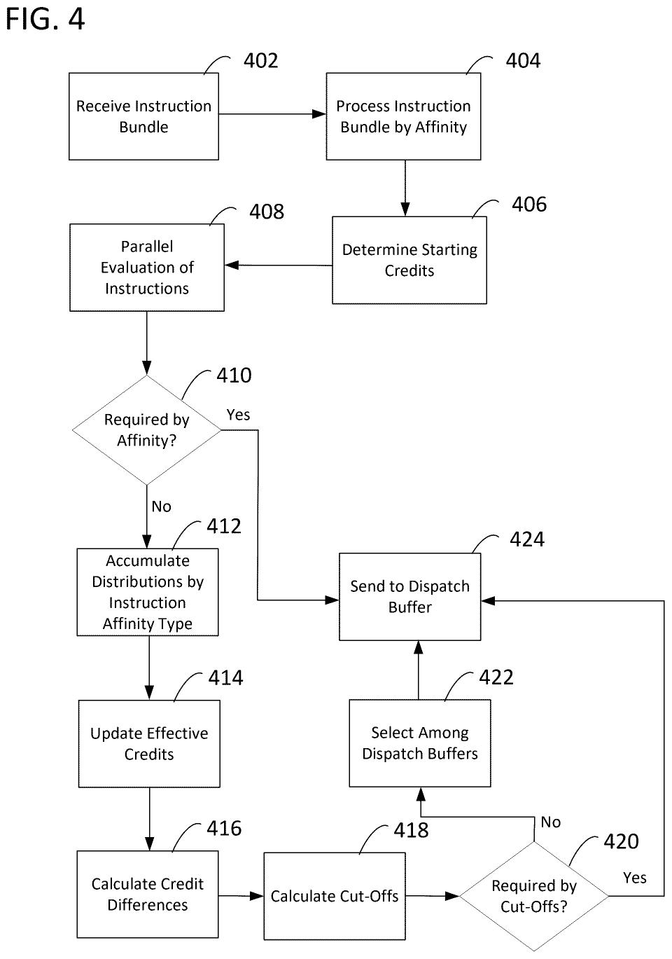

FIG. 4 depicts exemplary steps for the distribution of instructions to dispatch buffers based on credits and accumulated instructions in accordance with the present disclosure. Although particular steps are depicted in a particular order in FIG. 4, it will be understood that steps may be added, removed, or modified, and that ordering or flow of the steps may be modified.

Processing begins at step 402, at which logic circuits (e.g., of an instruction decoder/dispatch) receive a subset of instructions. The instructions may be received as a bundle of instructions and may include a number of instructions with different affinities. Processing may continue to step 404.

At step 404, the bundle of instructions is processed, for example, to determine a total number of each of an instruction affinity to be distributed, and in some embodiments, an order of distribution (e.g., based on order of being received, instruction affinity, etc.). Once the bundle of instructions has been processed, processing may continue to step 406.

At step 406, the logic circuits may communicate with the dispatch buffers (e.g., a token handshake) to acquire and/or determine information about the dispatch buffers, such as affinities accepted by each buffer and the amount of space available for each buffer. From this information, the logic circuits determine which dispatch buffers to include within the accumulation-and-credit based distribution scheme, the initial credits assigned to each buffer, which affinities must be distributed to particular buffers, and which buffers are to maintain their initial credit value versus decrement from the initial credit value, as described herein. Once the initial credits and processing rules for the bundle and dispatch buffers have been established, processing continues to step 408.

At step 408, a process of evaluating the instructions in the bundle in parallel commences. The process completes in step 424 when all the instructions have been sent to dispatch buffers. Different instructions in the bundle take different paths through the remaining steps prior to being queued for processing in step 424, as will be described below. However, each instruction in the bundle is considered for each branch of the process in order to complete the tables described above. Processing continues with step 410.

At step 410, it is determined whether the instruction is of an affinity that must be distributed to a particular dispatch buffer. If so, that instruction is accordingly queued for processing in step 424 to be sent to that particular dispatch buffer. However, the underlying values such as the difference values will still be calculated and maintained during the distribution process, for use with the other instructions in the bundle. Processing continues to step 412.

At step 412, the accumulation vector is calculated based on the affinities of the instructions in the bundle. For the first instruction all values will be zero. For later instructions in the bundle, the accumulation vector may be incremented (or otherwise increased) for each prior instruction in the bundle based on the affinity of each instruction. Once the accumulation vector is updated, processing may continue to step 414.

At step 414, the effective credits for each of the dispatch buffers are calculated. As described herein, initial starting credits are determined at step 406. Subsequently, the number of effective credits is reassessed based on the dispatch buffers to which the instructions are intended to be distributed. In some instances, it may have previously been determined that the values from the dispatch buffer are to remain at the initial credit value, for example, based on the affinity(ies) for the dispatch buffer, the affinity(ies) of the set of dispatch buffers, and/or amount of space in the dispatch buffer. If the dispatch buffer is of a type that gets modified (e.g., decremented), the modification is performed to update the effective credits for use in later steps. Processing then continues to step 416.

At step 416, difference values are calculated. Although difference values may be calculated in a variety of manners consistent with the present disclosure, in an embodiment the difference values are calculated for each dispatch buffer versus the dispatch buffer having the lowest number of effective credits, for example, by subtracting the number of effective credits for the dispatch buffers having the lowest number of effective credits. Once the difference values are calculated, processing continues to step 418.

At step 418, cut-off thresholds are calculated based on the credit difference values from step 416. For example, cut-off thresholds may be determined by subtracting higher effective credit values from lower effective credit values and adding higher effective credit values and lower effective credit values. Cut-off thresholds based on subtracted values are calibrated to ensure selection of higher availability dispatch buffers when other dispatch buffers have relatively lower availability, while cut-off thresholds based on added values facilitate selection between secondary dispatch buffers. Once the cut-off thresholds are calculated, processing may continue to step 420.

At step 420 the accumulation value for the instruction affinity from step 412 is compared to the cut-off thresholds. Based on the comparison, it may be determined that specific instructions may only be sent to one of the dispatch buffers, in which case those instructions are accordingly queued for processing in step 424. If multiple dispatch buffers may receive the instruction based on the comparison of the value from the accumulation vector and the cut-off thresholds, processing of those instructions then continues to step 422.

At step 422, the instruction may be distributed to one of multiple dispatch buffers. Which dispatch buffer receives the instruction is determined by distribution logic, for example, based on the instruction affinity, number of effective credits for the available buffers, in a round-robin fashion, or other appropriate criteria. Once the dispatch buffer to receive the instruction is selected, the instruction is queued for processing in step 424.

Processing arrives at step 424 from any of step 410 (e.g., affinity required to be distributed to one dispatch buffer), step 420 (e.g., instruction required to be distributed to a particular dispatch buffer based on cut-offs), or step 422 (e.g., possible to distribute instruction to multiple dispatch buffers based on cut-offs). At step 424, the instruction is distributed to the appropriate dispatch buffer. By performing a credits-based analysis to distribute instructions, the system may improve efficiency and throughput.

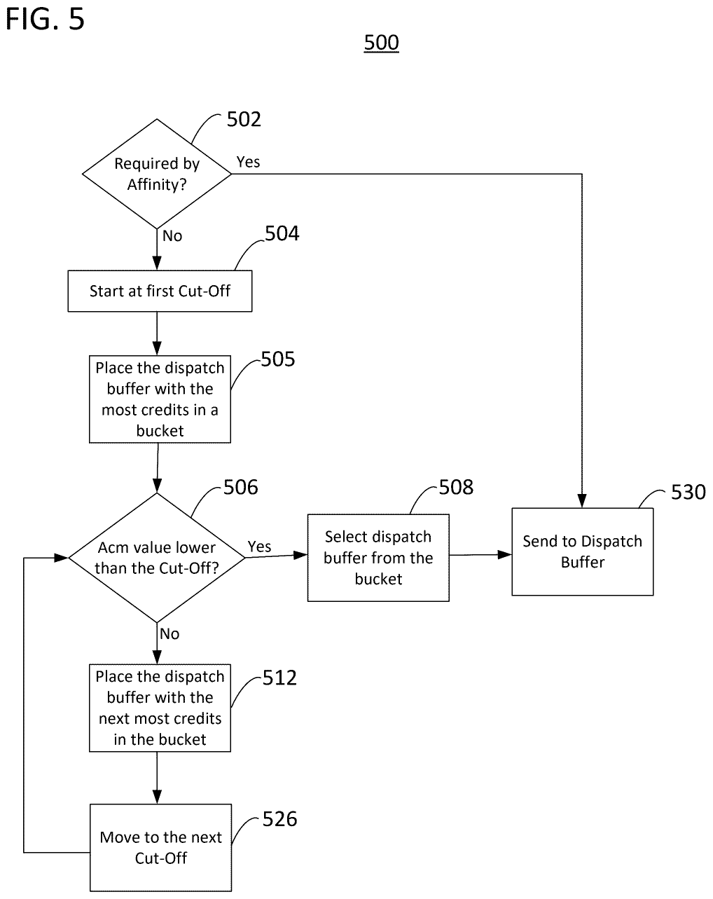

FIG. 5 illustrates an example of flowchart 500 for deciding to which dispatch buffer to allocate an instruction in accordance with the present disclosure. Some portions of flowchart 500 may be rearranged, omitted, or duplicated. Not all portions of flowchart 500 may apply for every example. Flowchart 500 may be performed by a system containing a plurality of dispatch buffers and a plurality of instructions.

At step 502, whether or not more than one dispatch buffer has an affinity for the instruction type may be determined. For example, if the instruction is a CALU instruction and only one dispatch buffer has an affinity for CALU instructions, then the instruction may be sent to that dispatch buffer (e.g., at step 530). If more than one dispatch buffer has an affinity for the instruction type, then further processing may occur.

At step 504, the system may consider the first Cut-Off (e.g., Cut-Off 1). The first Cut-Off, as well as other Cut-Offs, may be determined as illustrated in FIG. 2 and FIG. 3. As the process loops through steps 506, 512, and 526, the system may consider other Cut-Offs. For example, at step 526, the system moves to the next Cut-Off (e.g., Cut-Off 2, Cut-Off 3, etc.) down the ordered list of Cut-Offs. In other words, if the accumulation value for the instruction does not satisfy criteria for a Cut-Off, another Cut-Off may be considered until the accumulation value does satisfy the criteria for a Cut-Off.

At step 505, the dispatch buffer with the most credits may be placed in a bucket, where the bucket may be a list of selectable dispatch buffers. In other words, the bucket is an organizational tool for containing the options for the different dispatch buffers that an instruction may go to. The system may select a dispatch buffer from the bucket at step 508.

At step 506, the value of the accumulation vector corresponding to the type of instruction may be compared to the first Cut-Off to check whether the accumulation value is lower than the first Cut-Off. For example, if the instruction is a BR instruction, then the value of the accumulation vector corresponding to BR instructions is compared to the first Cut-Off. If the value of the accumulation vector is lower than the first Cut-Off, then the process may proceed to step 508. If the value of the accumulation vector is not lower than (e.g., equal to or greater than) the first Cut-Off, then the process may proceed to step 512.

At step 508, a dispatch buffer from the bucket may be selected. If step 506 has occurred exactly once, then the bucket may contain only one dispatch buffer, the dispatch buffer with the most effective credits (e.g., placed in the bucket at step 505). If step 506 has occurred more than once, then there may be multiple dispatch buffers in the bucket (e.g., placed in the bucket at step 505 and step 512), one of which is selected. In some embodiments the selection between multiple options for distribution may be based on rules or other criteria, for example, in a round-robin fashion or by defaulting to the dispatch buffer in the bucket having the highest effective credits. Referring to the example of FIG. 2, DB3 may be selected out of the group of selectable dispatch buffers in the bucket for instruction 215, the bucket containing DB4 and DB3. Once the dispatch buffer is selected, the instruction may be sent to that dispatch buffer at step 530.

At step 512, the dispatch buffer with the next most effective credits may be placed in the bucket (e.g., marked as selectable). For example, if this is the first occurrence of step 512, then the bucket already contains the dispatch buffer with the highest number of effective credits (added at step 505) and so, at step 512, the dispatch buffer with the second highest number of effective credits is added to the bucket (e.g., marked as selectable). If this is the second iteration of step 512, then the bucket already contains the dispatch buffer with the highest number of effective credits (added at step 505) and the dispatch buffer with the second highest number of effective credits (added at the previous iteration of step 512), and so, at this iteration of step 512, the dispatch buffer with the third highest number of effective credits is added to the bucket. Referring to the example of instruction 214 in FIG. 2, the ALU accumulated value is two and the Cut-Off 1 is two (such that the accumulated value is not less than Cut-Off 1), meaning that both DB4 (with five effective credits) and DB3 (with three effective credits) are selectable. The number of effective credits for the dispatch buffers may be determined as illustrated in FIG. 2 and FIG. 3.

At step 526, the process may move to the next Cut-Off in the list of Cut-Offs. Each iteration of the loop starting at step 506 uses a different Cut-Off as the starting point. The first implementation of step 506 uses the first Cut-Off (e.g., Cut-Off 1), the second implementation of step 506 uses the second Cut-Off (Cut-Off 2), and so on. Although the example of FIG. 2 only shows two Cut-Off values, many Cut-Off values may be calculated and used depending on various factors. Similarly, although the example of FIG. 2 only shows three dispatch buffers, any number of dispatch buffers may be available.

In specific embodiments, there may not be a “next Cut-Off.” In the example of FIG. 2, there are no values for Cut-Off 3. Accordingly, if the Cut-Off of step 506 refers to Cut-Off 2 (as this is the second implementation of step 506), then the next Cut-Off refers to an unvalued Cut-Off 3. In this case, the “next Cut-Off” may be understood as an arbitrarily high value in this context and any accumulation value higher than the Cut-Off (e.g., Cut-Off 2) may be considered as lower than the next Cut-Off (e.g., unvalued Cut-Off 3) at the subsequent step 506.

Processing arrives at step 530 from step 502 (e.g., affinity required to be distributed to one dispatch buffer) or step 508 (e.g., select the dispatch buffer from the bucket). At step 530, the instruction is distributed to the appropriate dispatch buffer. By performing a credits-based analysis to distribute instructions, the system may improve efficiency and throughput.

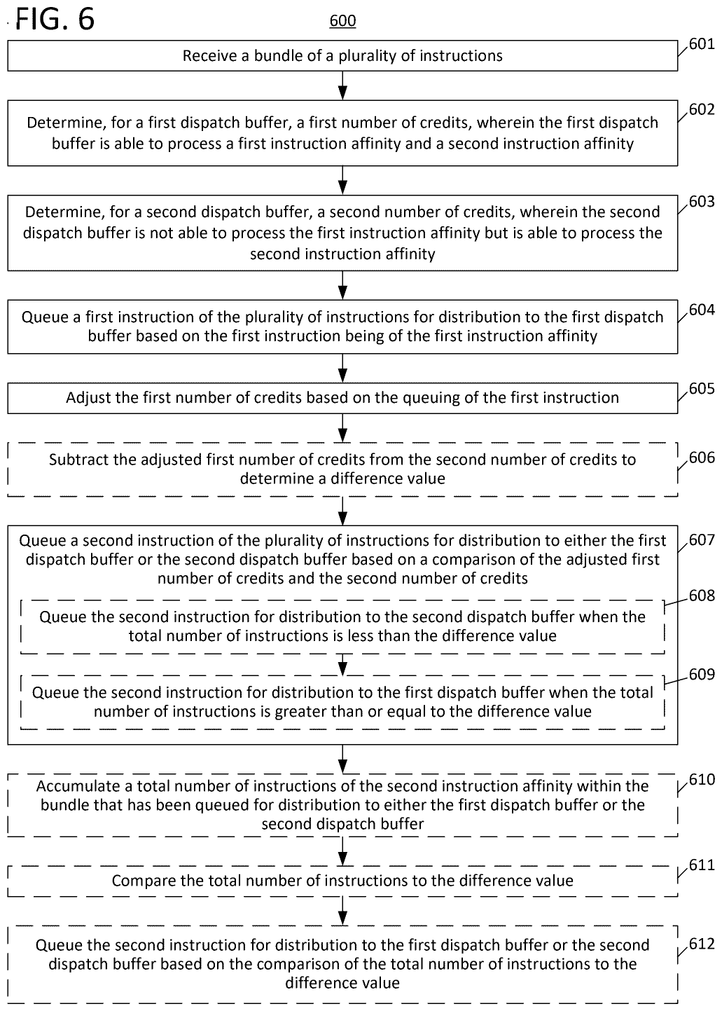

FIG. 6 illustrates an example of method 600 for distributing instructions to a first and a second dispatch buffer in accordance with the present disclosure. Method 600 may be performed by a device comprising a plurality of dispatch buffers, one or more processors, and instruction pipeline logic circuitry. Steps 601 through 612 (or portions thereof) may be omitted, duplicated, or rearranged.

At step 601, a bundle of a plurality of instructions may be received.

At step 602, a first number of credits may be determined for a first dispatch buffer. The first dispatch buffer may be able to process a first instruction affinity and a second instruction affinity. Affinities may help optimize resource allocation and streamline the execution process by ensuring that instructions are dispatched to the most suitable buffers. For example, certain dispatch buffers may be specialized for arithmetic or logic operations, while others may prioritize branch or memory-related instructions. Some of the dispatch buffers (e.g., for memory-related instructions) may be configured to handle instructions of only a single affinity, while other dispatch buffers may be able to handle multiple instruction affinities. In specific embodiments, the first instruction affinity may comprise a branch instruction. In specific embodiments, the first number of credits may be based on a first availability for instructions within the first dispatch buffer. In specific embodiments the first number of credits may be determined prior to distributing the first instruction.

At step 603, a second number of credits for a second dispatch buffer may be determined. The second dispatch buffer may not be able to process the first instruction affinity, but may be able to process the second instruction affinity. In specific embodiments, the second number of credits may be based on a second availability for instructions within the second dispatch buffer. In specific embodiments the second number of credits may be determined prior to distributing the first instruction.

At step 604, a first instruction of the plurality of instructions (e.g., received at step 601) may be queued for distribution to the first dispatch buffer. The first instruction may be queued for distribution to the first dispatch buffer based on the instruction being of the first instruction affinity. In specific embodiments, the first dispatch buffer may be the only dispatch buffer available to receive instructions that is able to process the first instruction type affinity.

At step 605, the first number of credits may be adjusted based on the queuing of the first instruction. In specific embodiments, the queuing of some instructions may affect the queuing of other instructions via adjusting the credits of the dispatch buffers.

In specific embodiments, at step 606, the adjusted first number of credits (e.g., adjusted at step 605) may be subtracted from the second number of credits (e.g., determined at step 603) to determine a difference value.

At step 607, a second instruction of the plurality of instructions (e.g., received at step 601) may be queued for distribution. The second instruction may be queued for distribution to either the first dispatch buffer to the second dispatch buffer based on a comparison of the adjusted first number of credits (e.g., adjusted at step 605) and the second number of credits (e.g., determined at step 603). In specific embodiments, the second number of credits may not be adjusted based on the queuing of the second instruction.

In specific embodiments, and as part of queuing the second instruction for distribution, at step 608, the second instruction may be queued for distribution to the second dispatch buffer when the total number of instructions is less than the difference value (e.g., determined at step 606).

In specific embodiments, and as part of queuing the second instruction for distribution, at step 609, the second instruction may be queued for distribution to the first dispatch buffer when the total number of instructions is greater than or equal to the difference value (e.g., determined at step 606).

In specific embodiments, at step 610, a total number of instructions of the second instruction affinity within the bundle that has been queued for distribution to either the first dispatch buffer or the second dispatch buffer may be accumulated.

In specific embodiments, at step 611, the total number of instructions (e.g., accumulated at step 610) may be compared to the difference value (e.g., determined at step 606).

In specific embodiments of the invention, at step 612, the second instruction may be queued for distribution. The second instruction may be queued for distribution to the first dispatch buffer or the second dispatch buffer based on the comparison (e.g., at step 611) of the total number of instructions to the difference value. In specific embodiments, the second number of credits may not be adjusted based on the queuing of the second instruction for distribution. Step 612 may be performed in conjunction with or as part of step 607. Performing a credits-based analysis to distribute instructions may improve efficiency and throughput.

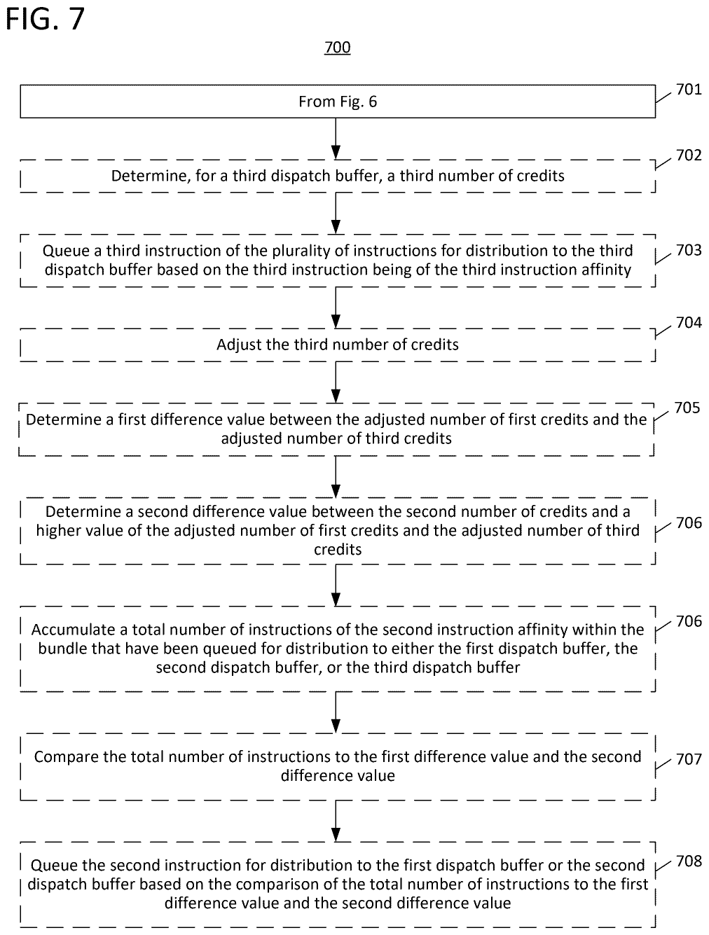

FIG. 7 illustrates an example of method 700 for distributing instructions to a first, a second, and a third dispatch buffer in accordance with the present disclosure. Method 700 may be performed by a device comprising a plurality of dispatch buffers, one or more processors, and instruction pipeline logic circuitry. Steps 701 through 708 (or portions thereof) may be omitted, duplicated, or rearranged. Aspects of method 600 may be incorporated into method 700.

At step 701, method 600 may occur. In other words, method 700 may include or be a continuation of method 600. In specific embodiments, some portions of method 600 may be left out of method 700.

In specific embodiments, at step 702, a third number of credits for a third dispatch buffer may be determined. The third dispatch buffer may be able to process a third instruction affinity and the second instruction affinity (e.g., the second instruction affinity of step 602). In specific embodiments, the third instruction affinity may comprise a complex ALU instruction.

In specific embodiments, at step 703, a third instruction of the plurality of instruction may be queued for distribution. The third instruction may be queued to the third dispatch buffer based on the third instruction being of the third instruction affinity. In specific embodiments, the second number of credits may not be adjusted based on the queuing of the third instruction.

In specific embodiments, at step 704, the third number of credits may be adjusted. The third number of credits may be adjusted based on the queuing of the third instruction for distribution (e.g., at step 703).

In specific embodiments, at step 705, a first difference value may be determined. The first difference value may be between the adjusted number of first credits (e.g., adjusted at step 605) and the adjusted number of third credits (e.g., adjusted at step 704).

In specific embodiments, at step 706, a second difference value may be determined. The second difference value may be between the second number of credits and a higher value of the adjusted number of first credits and the adjusted number of third credits.

In specific embodiments, at step 706, a total number of instructions of the second instruction affinity within the bundle that have been queued for distribution may be accumulated. The instructions may have been queued for distribution to either the first dispatch buffer, the second dispatch buffer, or the third dispatch buffer.

In specific embodiments, at step 707, the total number of instructions may be compared to the first difference value and the second difference value.

In specific embodiments, at step 708, the second instruction may be queued for distribution to the first dispatch buffer or the second dispatch buffer based on the comparison (e.g., at step 707) of the total number of instructions to the first difference value and the second difference value. Step 708 may be performed in conjunction with, or as part of, step 607. Performing a credits-based analysis to distribute instructions may improve efficiency and throughput.

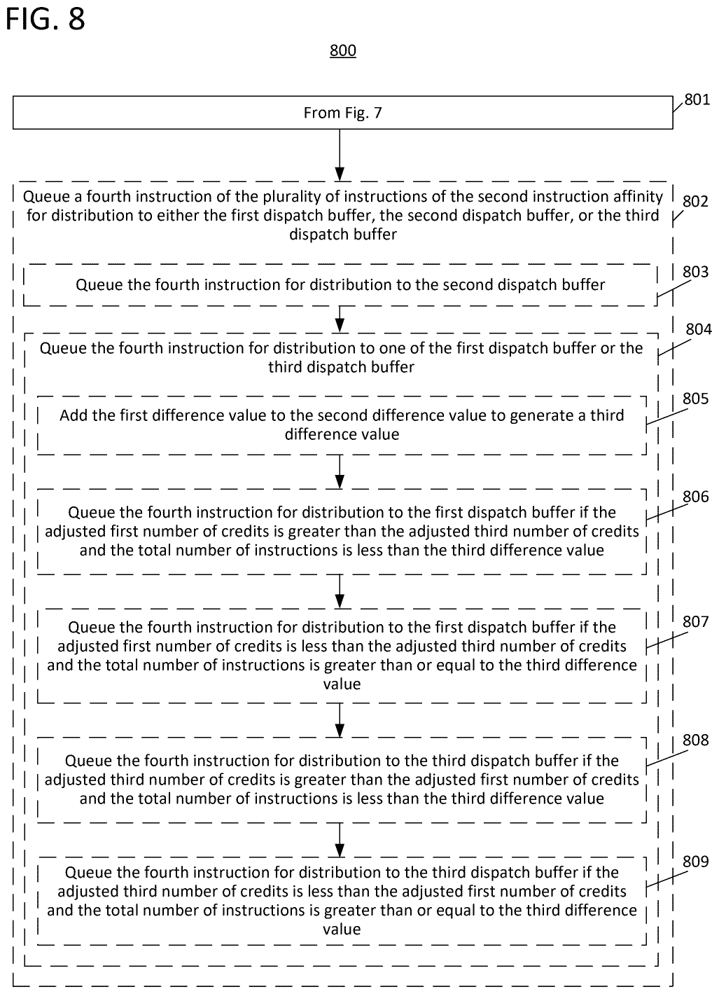

FIG. 8 illustrates an example of method 800 for distributing instructions to a first, a second, a third, and a fourth dispatch buffer in accordance with the present disclosure. Method 800 may be performed by a device comprising a plurality of dispatch buffers, one or more processors, and instruction pipeline logic circuitry. Steps 801 through 809 (or portions thereof) may be omitted, duplicated, or rearranged. Aspects of method 600 and/or method 700 may be incorporated into method 800.

At step 801, method 700 may occur. In other words, method 800 may include or be a continuation of method 700 (which itself includes or is a continuation of method 600). In specific embodiments, some portions of method 700 may be left out of method 800.

In specific embodiments, at step 802 a fourth instruction of the plurality of instructions of the second instruction affinity may be queued for distribution. The fourth instruction may be queued for distribution to either the first dispatch buffer, the second dispatch buffer, or the third dispatch buffer based on respective values for each of the adjusted first number of credits (e.g., adjusted at step 605), the second number of credits (e.g., determined at step 603), and the adjusted third number of credits (e.g., adjusted at step 704). Queuing the fourth instruction for distribution may be based on the first difference value (e.g., determined at step 705) and the second difference value (e.g., determined at step 706).

In specific embodiments, and as part of queuing the fourth instruction, at step 803, the fourth instruction may be queued for distribution to the second dispatch buffer. The total number of instructions may be less than the second difference value. In specific embodiments, the fourth instruction may be queued for distribution to the second dispatch buffer based on the total number of instructions being less than the second difference value.

In specific embodiments, and as part of queuing the fourth instruction, at step 804, the fourth instruction may be queued for distribution to one of the first dispatch buffer or the third dispatch buffer based on the first difference value wherein the total number of instructions is greater than or equal to the second difference value.

In specific embodiments, and as part of queuing the fourth instruction for distribution to one of the first dispatch buffer or the third dispatch buffer, at step 805, the first difference value may be added to the second difference value to generate a third difference value.

In specific embodiments, and as part of queuing the fourth instruction for distribution to one of the first dispatch buffer or the third dispatch buffer, at step 806, the fourth instruction may be queued for distribution to the first dispatch buffer if the adjusted first number of credits is greater than the adjusted third number of credits and the total number of instructions is less than the third difference value.

In specific embodiments, and as part of queuing the fourth instruction for distribution to one of the first dispatch buffer or the third dispatch buffer, at step 807, the fourth instruction may be queued for distribution to the first dispatch buffer if the adjusted first number of credits is less than the adjusted third number of credits and the total number of instructions is greater than or equal to the third difference value.

In specific embodiments, and as part of queuing the fourth instruction for distribution to one of the first dispatch buffer or the third dispatch buffer, at step 808, the fourth instruction may be queued for distribution to the third dispatch buffer if the adjusted third number of credits is greater than the adjusted first number of credits and the total number of instructions is less than the third difference value.

In specific embodiments, and as part of queuing the fourth instruction for distribution to one of the first dispatch buffer or the third dispatch buffer, at step 809, the fourth instruction may be queued for distribution to the third dispatch buffer if the adjusted third number of credits is less than the adjusted first number of credits and the total number of instructions is greater than or equal to the third difference value. Performing a credits-based analysis to distribute instructions may improve efficiency and throughput.

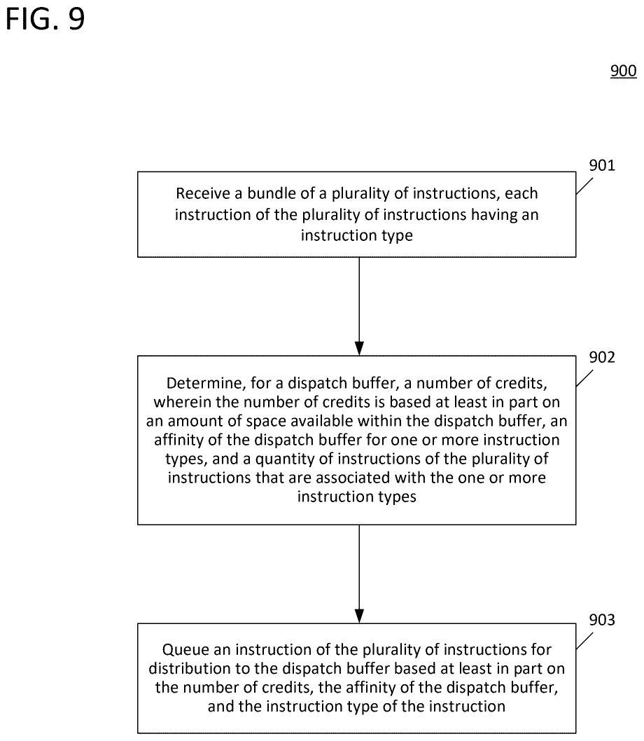

FIG. 9 illustrates an example of method 900 for distributing instructions to a dispatch buffer based on a number of credits in accordance with the present disclosure. Method 900 may be performed by a device comprising a plurality of dispatch buffers, one or more processors, and instruction pipeline logic circuitry. Steps 901, 902, and 903 (or portions thereof) may be omitted, duplicated, or rearranged. Aspects of method 600, method 700, and/or method 800 may be incorporated into method 900.

At step 901, a bundle of a plurality of instructions may be received. Each instruction of the plurality of instructions may have an instruction type. For example, an instruction may be an ALU instruction, a BR instruction, a CALU instruction, or another type of instruction.

At step 902, a number of credits for a dispatch buffer may be determined. The number of credits may be based on an amount of space available within the dispatch buffer, an affinity of the dispatch buffer for one or more instruction types (e.g., ALR, BR, CALU), and a quantity of instructions of the plurality of instructions that are associated with the one or more instruction types. For example, the number of credits for a dispatch buffering having an ALU affinity may account for the bundle of the plurality of instructions having five ALU instructions. As another example, the number of credits for a dispatch buffering having an ALU affinity and a BR affinity may account for the bundle of the plurality of instructions having three ALU instructions and four BR instructions.

At step 903, an instruction of the plurality of instructions may be queued for distribution to the dispatch buffer. The instruction may be queued for distribution to the dispatch buffer based on the number of credits (e.g., determined at step 902), the affinity of the dispatch buffer, and the instruction type of the instruction. For example, an instruction may be queued for distribution to the dispatch buffer based on the number of credits (e.g., an effective number of credits, a credit difference, etc.), the instruction being an ALU instruction, and the dispatch buffer having an affinity for ALU instructions. In this example, the dispatch buffer may also have an affinity for another type of instruction (e.g., BR or CALU instructions) or may only have an affinity for ALU instructions. Performing a credits-based analysis to distribute instructions may improve efficiency and throughput.

At least one processor in accordance with this disclosure can include at least one non-transitory computer readable media. The at least one processor could comprise at least one computational node in a network of computational nodes. The media could include cache memories on the processor. The media can also include shared memories that are not associated with a unique computational node. The media could be a shared memory, could be a shared random-access memory, and could be, for example, a double data rate dynamic random-access memory (DDR DRAM). The shared memory can be accessed by multiple channels. The non-transitory computer readable media can store data required for the execution of any of the methods disclosed herein, the instruction data disclosed herein, and/or the operand data disclosed herein. The computer readable media can also store instructions which, when executed by the system, cause the system to execute the methods disclosed herein. The concept of executing instructions is used herein to describe the operation of a device conducting any logic or data movement operation, even if the “instructions” are specified entirely in hardware (e.g., an AND gate executes an “and” instruction). The term is not meant to impute the ability to be programmable to a device.

While the specification has been described in detail with respect to specific embodiments of the invention, it will be appreciated that those skilled in the art, upon attaining an understanding of the foregoing, may readily conceive of alterations to, variations of, and equivalents to these embodiments. Any of the method steps discussed above can be conducted by a processor operating with a computer-readable non-transitory medium storing instructions for those method steps. The computer-readable medium may be memory within a personal user device or a network accessible memory. These and other modifications and variations to the present invention may be practiced by those skilled in the art, without departing from the scope of the present invention, which is more particularly set forth in the appended claims.

What is claimed is:

1. A method for distributing instructions to dispatch buffers, comprising:
receiving a bundle of a plurality of instructions;
determining, for a first dispatch buffer, a first number of credits, wherein the first dispatch buffer is able to process a first instruction affinity and a second instruction affinity;
determining, for a second dispatch buffer, a second number of credits, wherein the second dispatch buffer is not able to process the first instruction affinity but is able to process the second instruction affinity;
queuing a first instruction of the plurality of instructions for distribution to the first dispatch buffer based on the first instruction being of the first instruction affinity;
adjusting the first number of credits based on the queuing of the first instruction; and
queuing a second instruction of the plurality of instructions for distribution to either the first dispatch buffer or the second dispatch buffer based on a comparison of the adjusted first number of credits and the second number of credits.

2. The method of claim 1, wherein the comparison of the adjusted first number of credits and the second number of credits comprises a difference value based on a subtraction of the adjusted first number of credits from the second number of credits, further comprising:
accumulating a total number of instructions of the second instruction affinity within the bundle that has been queued for distribution to either the first dispatch buffer or the second dispatch buffer;
comparing the total number of instructions to the difference value; and
queuing the second instruction for distribution to the first dispatch buffer or the second dispatch buffer based on the comparison of the total number of instructions to the difference value.

3. The method of claim 2, wherein the queuing of the second instruction for distribution further comprises:
queuing the second instruction for distribution to the second dispatch buffer when the total number of instructions is less than the difference value; and
queuing the second instruction for distribution to the first dispatch buffer when the total number of instructions is greater than or equal to the difference value.

4. The method of claim 1, wherein the second number of credits is not adjusted based on the queuing of the second instruction for distribution.

5. The method of claim 1, further comprising:
determining, for a third dispatch buffer, a third number of credits, wherein the third dispatch buffer is able to process a third instruction affinity and the second instruction affinity;
queuing a third instruction of the plurality of instructions for distribution to the third dispatch buffer based on the third instruction being of the third instruction affinity;
adjusting the third number of credits based on the queuing of the third instruction for distribution; and
queuing a fourth instruction of the plurality of instructions of the second instruction affinity for distribution to either the first dispatch buffer, the second dispatch buffer, or the third dispatch buffer based on respective values of each of the adjusted first number of credits, the second number of credits, and the adjusted third number of credits.

6. The method of claim 5, further comprising:
determining a first difference value between the adjusted number of first credits and the adjusted number of third credits; and
determining a second difference value between the second number of credits and a higher value of the adjusted number of first credits and the adjusted number of third credits, wherein the queuing of the fourth instruction for distribution is based on the first difference value and the second difference value.

7. The method of claim 6, further comprising:
accumulating a total number of instructions of the second instruction affinity within the bundle that have been queued for distribution to either the first dispatch buffer, the second dispatch buffer, or the third dispatch buffer;
comparing the total number of instructions to the first difference value and the second difference value; and
queuing the second instruction for distribution to the first dispatch buffer or the second dispatch buffer based on the comparison of the total number of instructions to the first difference value and the second difference value.

8. The method of claim 7, wherein the queuing of the fourth instruction for distribution further comprises:
queuing the fourth instruction for distribution to the second dispatch buffer wherein the total number of instructions is less than the second difference value; and
queuing the fourth instruction for distribution to one of the first dispatch buffer or the third dispatch buffer based on the first difference value wherein the total number of instructions is greater than or equal to the second difference value.

9. The method of claim 8, wherein the queuing of the fourth instruction for distribution to one of the first dispatch buffer or the third dispatch buffer based on the first difference value comprises:
adding the first difference value to the second difference value to generate a third difference value;
queuing the fourth instruction for distribution to the first dispatch buffer if the adjusted first number of credits is greater than the adjusted third number of credits and the total number of instructions is less than the third difference value;
queuing the fourth instruction for distribution to the first dispatch buffer if the adjusted first number of credits is less than the adjusted third number of credits and the total number of instructions is greater than or equal to the third difference value;
queuing the fourth instruction for distribution to the third dispatch buffer if the adjusted third number of credits is greater than the adjusted first number of credits and the total number of instructions is less than the third difference value; and
queuing the fourth instruction for distribution to the third dispatch buffer if the adjusted third number of credits is less than the adjusted first number of credits and the total number of instructions is greater than or equal to the third difference value.

10. The method of claim 7, wherein the second number of credits is not adjusted based on the queuing of the second instruction or the queuing of the third instruction.

11. The method of claim 10, wherein the first instruction affinity comprises a branch instruction and the third instruction affinity comprises a complex ALU instruction.

12. The method of claim 1, wherein the first number of credits is based on a first availability for instructions within the first dispatch buffer and the second number of credits is based on a second availability for instructions within the second dispatch buffer.

13. The method of claim 12, wherein the first number of credits and the second number of credits are determined prior to distributing the first instruction.

14. A device, comprising:
a plurality of dispatch buffers including a first dispatch buffer and a second dispatch buffer;
one or more processors; and
instruction pipeline logic circuitry programmed to conduct a method for distributing instructions to the plurality of dispatch buffers, the method comprising:
receiving a bundle of a plurality of instructions;
determining, for the first dispatch buffer, a first number of credits, wherein the first dispatch buffer is able to process a first instruction affinity and a second instruction affinity;
determining, for the second dispatch buffer, a second number of credits, wherein the second dispatch buffer is not able to process the first instruction affinity but is able to process the second instruction affinity;
queuing a first instruction of the plurality of instructions for distribution to the first dispatch buffer based on the first instruction being of the first instruction affinity;
adjusting the first number of credits based on the queuing of the first instruction; and
queuing a second instruction of the plurality of instructions for distribution to either the first dispatch buffer or the second dispatch buffer based on a comparison of the adjusted first number of credits and the second number of credits.

15. The device of claim 14, wherein the comparison of the first number of credits and the second number of credits comprises a difference value based on a subtraction of the adjusted first number of credits from the second number of credits, and the method further comprises:
accumulating a total number of instructions of the second instruction affinity within the bundle that has been queued for distribution to either the first dispatch buffer or the second dispatch buffer;
comparing the total number of instructions to the difference value; and
queuing the second instruction for distribution to the first dispatch buffer or the second dispatch buffer based on the comparison of the total number of instructions to the difference value.

16. The device of claim 15, wherein the queuing of the second instruction for distribution further comprises:
queuing the second instruction for distribution to the second dispatch buffer when the total number of instructions is less than the difference value; and
queuing the second instruction for distribution to the first dispatch buffer when the total number of instructions is greater than or equal to the difference value.

17. The device of claim 14, wherein the second number of credits is not adjusted based on the queuing of the second instruction for distribution.

18. The device of claim 14, wherein the method further comprises:
determining, for a third dispatch buffer of the plurality of dispatch buffers, a third number of credits, wherein the third dispatch buffer is able to process a third instruction affinity and the second instruction affinity;
queuing a third instruction of the plurality of instructions for distribution to the third dispatch buffer based on the third instruction being of the third instruction affinity;
adjusting the third number of credits based on the queuing of the third instruction for distribution; and
queuing a fourth instruction of the plurality of instructions of the second instruction affinity for distribution to either the first dispatch buffer, the second dispatch buffer, or the third dispatch buffer based on respective values of each of the adjusted first number of credits, the second number of credits, and the adjusted third number of credits.

19. The device of claim 18, wherein the method further comprises:
determining a first difference value between the adjusted number of first credits and the adjusted number of third credits; and
determining a second difference value between the second number of credits and a higher value of the adjusted number of first credits and the adjusted number of third credits, wherein the queuing of the fourth instruction for distribution is based on the first difference value and the second difference value.

20. A method for distributing instructions to dispatch buffers, comprising:
receiving a bundle of a plurality of instructions, each instruction of the plurality of instructions having an instruction type;
determining, for a dispatch buffer, a number of credits, wherein the number of credits is based at least in part on an amount of space available within the dispatch buffer, an affinity of the dispatch buffer for one or more instruction types, and a quantity of instructions of the plurality of instructions that are associated with the one or more instruction types; and
queuing an instruction of the plurality of instructions for distribution to the dispatch buffer based at least in part on the number of credits, the affinity of the dispatch buffer, and the instruction type of the instruction.
